(19) United States
(12) Patent Application Publication
(10) Pub. No.: US 2016/0350761 A1
(43) Pub. Date: Dec. 1, 2016

(54) Method and Apparatus for Managing Reference Templates for User Authentication Using Behaviometrics

(71) Applicant: Intel Corporation, Santa Clara, CA (US)

(72) Inventors: Michael Raziel, Jerusalem (IL); Ned M. Smith, Beaverton, OR (US); Alex Nayshtut, Gan Yavne (IL); Hormuzd M. Khosravi, Portland, OR (US); Abhilasha Bhargav-Spantzel, Santa Clara, CA (US); Meir Shaked, Rehovot (IL)

(73) Assignee: Intel Corporation

(21) Appl. No.: 14/724,025

(22) Filed: May 28, 2015

(51) Int. Cl. G06Q 20/40

(52) U.S. Cl. CPC G06Q 20/40145; G06Q 2220/00

(57) ABSTRACT

A method for managing a reference template for authentication includes generating the reference template using gait data collected during a training period. A user is authenticated utilizing the reference template. A universal background model (UBM) is generated using gait data collected after the training period. The reference template is updated using the UBM.

### TECHNICAL FIELD

Embodiments of the present disclosure pertain to authentication systems. More specifically, embodiments of the present disclosure relate to a method and apparatus for managing reference templates for user authentication using behaviometrics.

### BACKGROUND

A variety of different identity authentication methods are available for use today. Commonly used methods include knowledge-based authentication where a user enters a secret, such as a personal identification number or a password. Token-based authentication methods require the user to present a physical object or enter a digital code generated from a token generator. Biometric-based authentication methods authenticate a user based on biometric identifiers, which are distinctive, measurable characteristics used to label and describe individuals.

Biometric identifiers may be categorized as being physiological characteristics or behavior characteristics. Physiologic characteristics are related to the shape of the body. Some examples may include fingerprints, facial features, hand geometry, and iris geometry. Behavior characteristics are related to the pattern of behavior of a person. Some examples may include the typing rhythm, gait, and voice of a person. The term “behaviometrics” has been used to describe the behavior characteristics of the user.

Biometric-based authentication methods offer an advantage over knowledge-based authentication methods and token-based authentication methods by offering users the freedom from having to remember a secret or to carry a physical object. Innovations in mobile computing devices, such as smart phones and tablet computers, provide users with tools that support biometric-based authentication. Many mobile computing devices include sensors which may be configured to sense various environmental or user conditions or criteria. For example, the camera or touch screen of the mobile device may utilized as fingerprint or retina scanners.

### BRIEF DESCRIPTION OF THE DRAWINGS

The features and advantages of embodiments of the present disclosure are illustrated by way of example and are not intended to limit the embodiments of the present disclosure to the particular embodiments shown.

FIG. 1 is a block diagram of a computing environment according to an exemplary embodiment of the present disclosure.

FIG. 2 is a block diagram of a trusted execution environment according to an exemplary embodiment of the present disclosure.

FIG. 3 is a flow chart illustrating a method for managing reference templates for user authentication according to an exemplary embodiment of the present disclosure.

FIG. 4 is a flow chart illustrating a method for generating a reference template according to an exemplary embodiment of the present disclosure.

FIG. 5 is a flow chart illustrating a method for updating a reference template with a universal background model according to an exemplary embodiment of the present disclosure.

FIG. 6 is a flow chart illustrating a method for determining whether to generate a new universal background model according to an exemplary embodiment of the present disclosure.

FIG. 7 is a block diagram illustrating an authentication system according to an exemplary embodiment of the present disclosure.

FIG. 8 is a diagram illustrating an example of a commerce transaction utilizing an authentication procedure according to an exemplary embodiment of the present disclosure.

### DETAILED DESCRIPTION

In the following description, for purposes of explanation, specific nomenclature is set forth to provide a thorough understanding of embodiments of the present disclosure. It will be apparent to one skilled in the art that specific details in the description may not be required to practice the embodiments of the present disclosure. In other instances, well-known circuits, devices, procedures, and programs are shown in block diagram form to avoid obscuring embodiments of the present disclosure unnecessarily.

According to an embodiment of the present disclosure, a behaviometric authentication system learns a user model from the user's past behavior which characterizes the user's behavior pattern during a training period. The user model may be referred to as a reference template. Given the reference template and some recently observed behavior of an individual, the authentication system computes a probability value that the observed behavior belongs to the user and utilizes the probability value to determine whether the individual is the user. For example, a threshold value may be utilized to determine whether to accept or reject the individual as the user.

One of the challenges for behaviometric authentication systems is learning the user model to generate the reference template. In order to generate a reference template that accurately captures the user's behavior, sufficient data needs to be sampled during the training period. The more data that is sampled, the more accurate and robust the reference template may be. Collecting data of the user's behavior may require a long period of time which is undesirable. Furthermore, even after sufficient data has been collected during the training period to generate a reference template, new user behavior or changed user behavior may occur which may not be reflected in the generated reference template.

According to an embodiment of the present disclosure, a continuous learning procedure for behaviometric reference templates is disclosed which allows a reference template to be updated to include new or changed user behavior after an initial training period. The reference template is generated using gait data collected during the initial training period. The reference template may be used to authenticate an individual as the user. A universal background model (UBM) is generated using gait data collected from the user after the training period. The reference template is updated using the UBM to include any new or changed user behavior.

Embodiments of the present disclosure may provide potential advantages such as allowing a reference template to be updated with current user behavior that may not be reflected in data collected during an initial training period. Embodiments of the present disclosure also provide the potential advantage of allowing the initial training period to be shortened by leveraging the continuous learning aspect of the disclosure which utilizes additional UBMs generated after the initial training period.

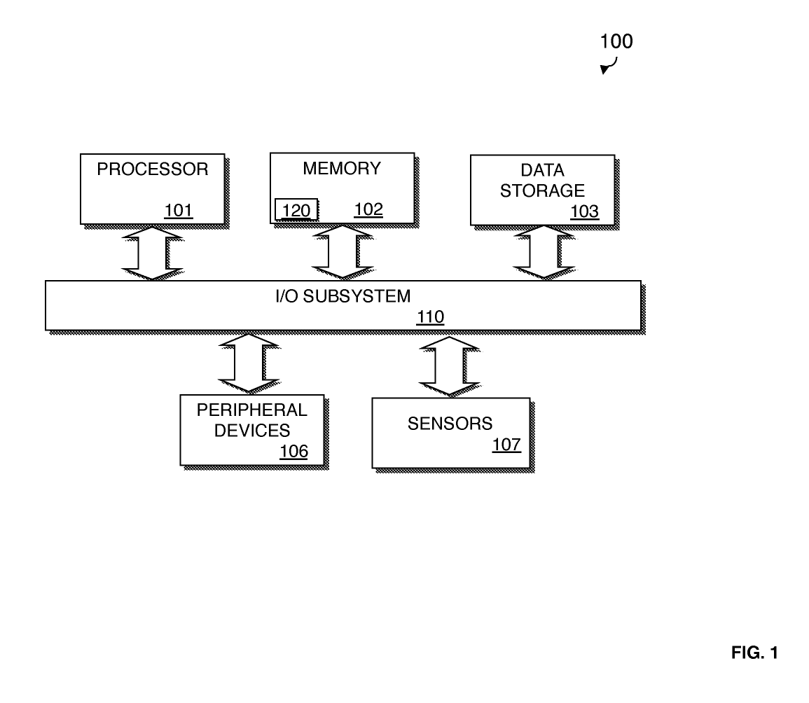

FIG. 1 is a block diagram of a computing device 100 according to an exemplary embodiment of the present disclosure. The computing device 100 may be implemented by a smart phone, tablet, smart watch, smart appliance, or other computing device. The computing device 100 includes a processor 101 that processes data signals. FIG. 1 shows the computing device 100 with a single processor. However, it is understood that the computing device 100 may operate with multiple processors. The processor 101 may be implemented by a single or multi-core processor(s), digital signal processor, microcontroller, or other processor or processing/controlling circuit.

The processor 101 is coupled to an input/output (I/O) subsystem 110. The I/O subsystem 110 may include memory controller hubs, I/O control hubs, communication links, and/or other components and subsystems to facilitate I/O operations. According to an embodiment of the computing device 100, the I/O subsystem 110 transmits data signals between components in the computing device 100. In this embodiment, the I/O subsystem 110 may include a single bus or a combination of multiple buses. The computing device 100 includes a memory 102. The memory 102 is coupled to the I/O subsystem 110. The memory 102 may be a dynamic random access memory device, a static random access memory device, and/or other memory device. The memory 102 may store instructions and code represented by data signals that may be executed by the processor 101. A data storage device 103 is coupled to the I/O subsystem 110. The data storage device 103 may be implemented with a device configured for short-term or long-term storage of data such as a solid state drive, memory card or other mass storage device.

Peripheral devices 106 are coupled to the I/O subsystem 110. The peripheral devices 106 may include various I/O devices such as devices that support communication and display. The peripheral devices 106 may include display and touch screens, buttons, switches, keyboard, mouse, speakers, microphone, and/or other peripheral devices. Sensors 107 are coupled to the I/O subsystem 110 and may be embodied as one or more sensors. According to an embodiment of the disclosure, the sensors 107 may include one or more motion, location, and proximity sensors, and/or one or more other sensors capable of generating data useful for authenticating a user, such as gait data.

The motion sensors may be embodied as any type of sensor(s) capable of generating data indicative of a motion of the computing device 100 including, but not limited to, a gyroscope sensor, an accelerometer, an inertial motion unit, and/or other motion sensors. The motion sensors may be configured to generate sensor data indicative of how the user interacts with the computing device 100 while performing certain tasks of functions on the computing device 100. For example, the generated motion data may provide an indication of how the computing device 100 is held when performing various tasks on the computing device 100.

The location sensors may be embodied as any type of sensor(s) capable of generating data indicative of a location of the computing device 100 including, but not limited to a global positioning system (GPS) sensor, a triangulation or trilateration sensor, and/or other location sensors. The location sensors may be configured to generate sensor data indicative of the location at which the user utilizes the computing device 100 and/or the location where the user utilizes specific functions of the computing device 100. For example, the generated location sensor data may provide a location where the user uses the computing device 100 to perform various tasks such as making a call, accessing an application, data, or website, or other task.

The vicinity sensor may be embodied as any type of sensor(s) capable of generating data indicative of the local vicinity in which the computing device 100 is used, as well as spatial relationship between the computing device 100 and other structures, devices, or entity. For example, the vicinity sensors may include camera sensors, audio sensors, short-range communication sensors, such as near field communication circuitry and Bluetooth communication circuitry, and/or other vicinity sensors. In use, the vicinity sensors may be configured to generate sensor data indicative of the local vicinity or spatial proximity of the computing device 100 while the user utilizes specific functions on the computing device 100 that provides more specificity than the location sensor data. For example, the vicinity sensor data may provide an indication that the computing device 100 is in a pocket, on a table, near an ear, near another computing device, and/or other vicinity when the user utilizes a particular function on the computing device 100.

According to an embodiment of the present disclosure, the sensors 107 may be implemented by user-wearable devices. The sensors 107 may also include circuitry that measure a user's electrical activity in the heart (electrocardiogram), body temperature, perspiration, pH, muscle activity, neuron activity in the brain, and/or other metrics specific to the user. It should be appreciated that the sensors 107 described may be collectively used to generate gait data for a user.

According to an embodiment of the present disclosure, an authentication system 120 resides in memory 102 and is executed by the processor 101. According to an aspect of the disclosure, the authentication system 120 transforms the processor 101 into a special purpose processor. The authentication system 120 utilizes gait data to passively and continuously authenticate a user without requiring the user to actively interact with the authentication system. The authentication system 120 learns the user's behaviometrics during an initial training period and generates a reference template. The collected gait data is compared against data in the reference template to passively and continuously authenticate the user. After the initial training period, additional universal background models may be generated from new gait data collected from the user. The additional universal background models may be used to update the reference template to improve its accuracy.

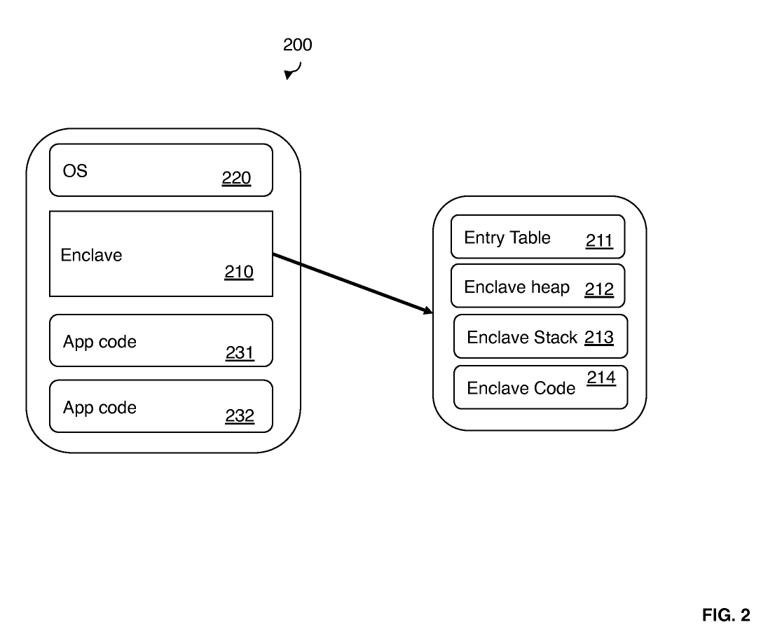

FIG. 2 is a block diagram of a trusted execution environment 210 according to an exemplary embodiment of the present disclosure. According to an embodiment of the present disclosure, the trusted executed environment 210 is created inside a memory 200. The memory 200 may be used to implement the memory 102 (shown in FIG. 1) and may be used to protect the authentication system 120 (shown in FIG. 1), reference template, universal background model, and data collected from sensors 107 (shown in FIG. 1) from being compromised.

The memory 200 includes a conventional storage area to store programs such as an operating system 220 and application code 231 and 232. The memory 200 also includes the trusted execution environment 210 which may also be referred to as an “enclave”. The trusted execution environment 210 is a separated and encrypted region for code and data and is only decrypted inside a processor, such as the processor 101 shown in FIG. 1. The trusted execution environment 210 provides confidentiality and integrity in the presence of malware. Accesses to the trusted execution environment 210 from any software not resident in the trusted execution environment 210 are prevented. The trusted execution environment 210 may prove its identity to a remote party and provide necessary building blocks for secure provisioning of keys and credentials. According to an embodiment of the present disclosure, the trusted execution environment 210 may transmit a signature which may be used to authenticate its trustworthiness to the remote party.

As shown in FIG. 2, the trusted execution environment 210 stores an entry table 211, heap 212, stack 213, and code 214. The trusted execution environment 210 may be implemented as a secure mode of a processor where locations in memory 200, execution threads and interrupts are assigned where such assignment is not observable by other virtualization layers such as ring-3, ring-2, ring-1, ring-0 processes or by ring-(−1). Intel® Software Guard Extensions (SGX) and Intel® MemCore virtualization engine are examples of CPU-based enclaves. It should be appreciated that an enclave may also be implemented in a chipset or system on a chip (SoC) intellectual property (IP) block that includes a general purpose co-processing unit or a special purpose controller, application specific integrated circuit (ASIC), or a floating point unit (FPU). The trusted execution environment 210 does not share memory locations, interrupts, heap 212, stack 213, or code 214 with the processor in order for it to function independently from the processor. Intel® Converged Security Engine (CSE) and Intel® Manageability Engine (ME) are examples of enclave-processing environments that support a trusted execution environment 210.

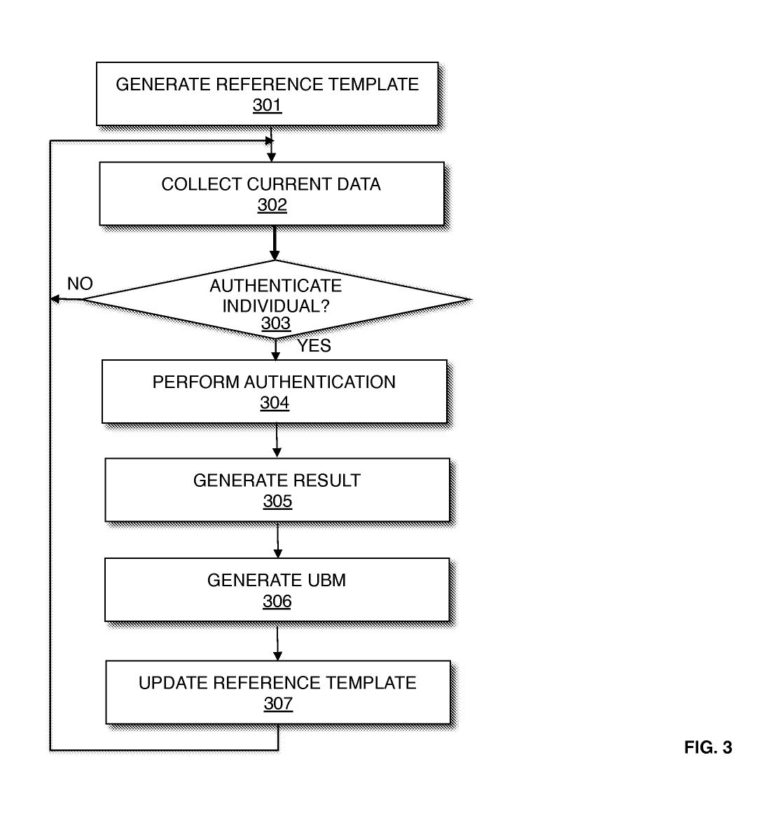

FIG. 3 is a flow chart illustrating a method for managing a reference template for user authentication according to an exemplary embodiment of the present disclosure. The procedures described in FIG. 3 may be implemented by a processor such as the processor 101 illustrated in FIG. 1.

At 301, a reference template is generated. According to an embodiment of the present disclosure, the reference template includes data that corresponds to a user that characterizes the user's behavior pattern. The data may include behaviometric data sampled from sensors during an initial training period. The reference template may be used to authenticate the user.

At 302, current data is collected. According to an embodiment of the present disclosure, the current data is collected from sensors on a computing device. The current data may correspond to an individual that may or may not be the user.

At 303, a determination is made whether to test the authenticity of the individual. If the authenticity of the individual is to be tested, control proceeds to 304. If the authenticity of the individual is not to be tested, control returns to 302. According to an embodiment of the present disclosure, the determination on whether to test the authenticity of the individual may be based on an initiation of a transaction, a request to utilize functions on the computing device, an attempt to access data, an expiration of a predetermined period of time, and/or other triggering event. In an alternate embodiment, the authenticity of the individual is continuously tested without requiring the triggering event.

At 304, the authentication of the individual is tested. According to an embodiment of the present disclosure, the authenticity of the individual is tested by comparing current data associated with the individual collected at 302 with data in the reference template generated at 301. The individual is determined to be authentic if the current data associated with the individual exceeds a threshold amount of matching with the reference template. It should be appreciated that various techniques may be implemented to perform the comparison and matching including probabilistic and machine learning techniques that arrive at a False Accept Rate (FAR) and False Reject Rate (FRR) for common comparisons of quality that are independent of sensor type.

At 305, test results are generated. According to an embodiment of the present disclosure, the test result indicates whether the individual has been authenticated and is the user. The test result may be output on the computing device and/or transmitted outside the computing device.

At 306, a universal background model is generated. According to an embodiment of the present disclosure, the universal background model includes additional data that corresponds to the user that further characterizes the user's behavior pattern. The data may include additional behaviometric data sampled from sensors after the initial training period.

At 307, the reference template is updated utilizing data from the universal background model. According to an embodiment of the present disclosure, a learning anomaly detection technique such as a Bayesian inference algorithm is applied to the universal background model and the reference template. Hamming distance between minutia points in the reference template and universal background model are computed. The minutia points in the reference template are adjusted by summing the natural log of the computed Hamming distances. It should be appreciated that the computation of Hamming distances and summing ensures the universal background model may ‘drift’ away from the reference template so that authentication confidence remains strong while also allowing new trained behavior to be incorporated into the acceptance criteria.

It should be appreciated that the reference template may be updated utilizing data from the universal background in a different manner. For instance, if a determination is made that the universal background model captured new behavior of the user not reflected in the reference template, the data from the universal background model may be added to the reference template. Control returns to 302.

The authentication performed at 304, the generating performed at 306, and the updating performed at 307 may be performed continuously, and passively (i.e. without active participation by the individual or user). This allows the authentication, generating, and updating to occur passively, without knowledge and/or interruption of the individual or user

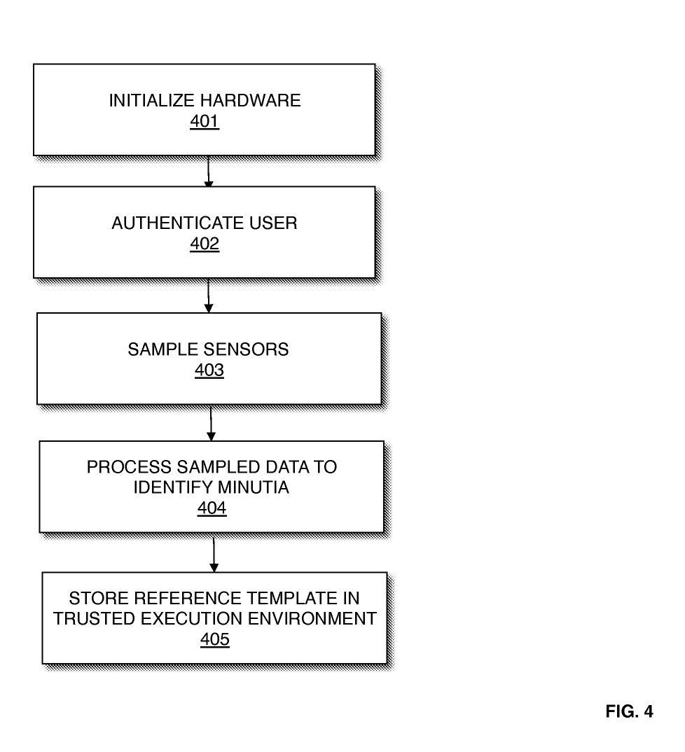

FIG. 4 is a flow chart illustrating a method for generating a reference template according to an exemplary embodiment of the present disclosure. The procedures illustrated in FIG. 4 may be used to implement procedure 301 illustrated in FIG. 3.

At 401, hardware is initialized. According to an embodiment of the present, disclosure, the hardware initialized may include motion, location, and vicinity sensors on a computing device.

At 402, the user for which the reference template is created for is authenticated. According to an embodiment of the present disclosure, the authentication may be performed using a variety of different available techniques including 2-step authentication.

At 403, the sensors are sampled to collect data. According to an embodiment of the present disclosure, motion sensors are sampled to collect gait data. It should be appreciated that other sensors may also be sampled to collect additional data.

At 404, the data collected from the sensors is processed. According to an embodiment of the disclosure, the data is processed to identify minutia, such as gait minutia, corresponding to the user. The processing may include applying one or more filters to the data to remove components associated with behavior or activity related to noise. For example, motion related to movement from riding in a car may be filtered out from the data. The processing may further include identifying more frequently occurring behavior or activity as minutia corresponding to the user. The minutia is used to create a reference template that describes the user's characteristics.

At 405, the reference template is stored in a trusted execution environment.

The reference template may be generated during an initial training period using data collected from sensors on a same computing device which is used to later perform behaviometric authentication. It should be appreciated that in alternative embodiments of the present disclosure that the reference template may be generated on a different computing device or using sensors from a different computing device. In this embodiment, the data collected or the generated reference template may be transmitted to the computing device performing behaviometric authentication.

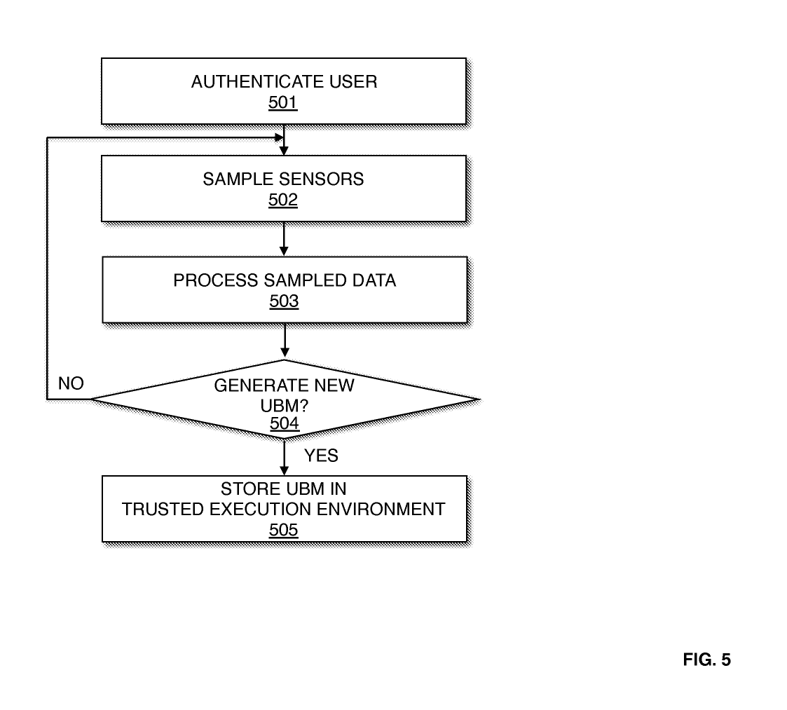

FIG. 5 is a flow chart illustrating a method for generating a universal background model according to an exemplary embodiment of the present disclosure. The procedures illustrated in FIG. 5 may be used to implement procedure 306 illustrated in FIG. 3.

At 501, an individual is authenticated. According to an embodiment of the present disclosure, the individual may be authenticated by utilizing a reference template and performing procedure 304 as described with reference to in FIG. 3. Alternatively, other authentication techniques may be used. Upon authenticating the individual as the user, control proceeds to 502.

At 502, sensors are sampled to collect data. According to an embodiment of the present disclosure, the sensors that are sampled are motion sensors and gait data is collected. It should be appreciated that other sensors may be sampled and other data may be collected.

At 503, the data is processed. According to an embodiment of the disclosure, the data is processed to identify minutia, such as gait minutia, corresponding to the user. The processing may include applying one or more filters to the data to remove components associated with behavior or activity related to noise. The processing may further include identifying more frequently occurring behavior or activity as minutia corresponding to the user. The gait minutia is used to create a universal background model that describes the user's characteristics.

At 504, it is determined whether a new universal background model should be generated. If a new universal background model should be generated, control proceeds to 505. If a new universal background model should not be generated, control returns to 502.

At 505, the universal background model is stored in a trusted execution environment.

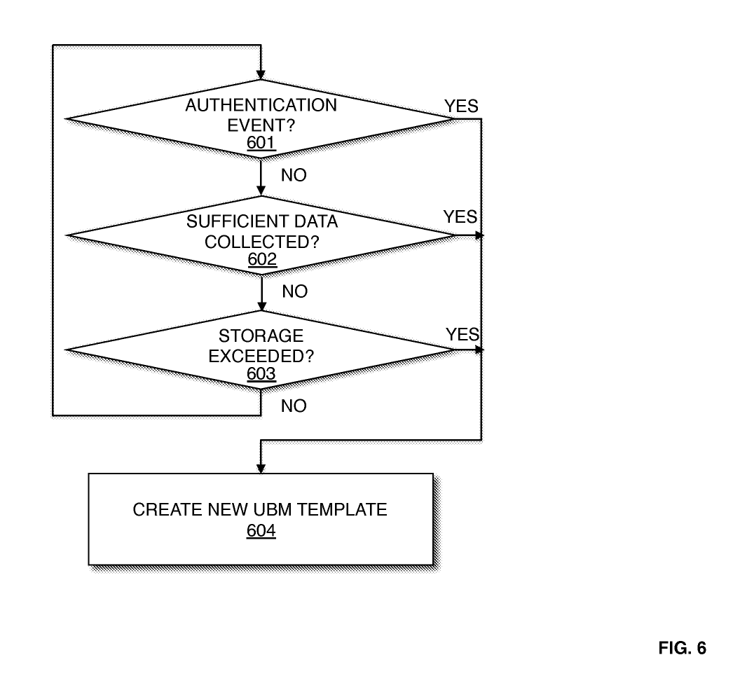

FIG. 6 is a flow chart illustrating a method for determining whether to generate a new universal background model according to an exemplary embodiment of the present disclosure. The procedures illustrated in FIG. 6 may be used to implement procedure 504 illustrated in FIG. 5.

At 601, it is determined whether an authentication event has occurred. An authentication event occurs when an individual has been authenticated as a user. According to an embodiment of the present disclosure, the authentication may occur by comparing current data associated with the individual with a reference template associated with the user, or using other biometric, knowledge, or token-based authentication technique for authenticating the individual as the user. If it is determined that the authentication event has occurred, control proceeds to 604. If it is determined that the authentication event has not occurred, control proceeds to 602.

At 602, it is determined whether sufficient data has been collected for a universal background model. According to an embodiment of the present disclosure, a threshold quantity of data may be predefined as being sufficient for creating universal background model. If it is determined that sufficient data has been collected for the universal background model, control proceeds to 604. If it is determined that sufficient data has not been collected for the universal background model, control proceeds to 603.

At 603, it is determined whether storage capacity for storing data collected for the universal background model has been exceeded. According to an embodiment of the present disclosure, storage capacity may be exceeded when a predefined amount of space in a memory has been exceeded for storing current data sampled from sensors. If it is determined that storage capacity for data collected for the universal background model has been exceeded, control proceeds to 604. If it is determined that storage capacity for data collected for the universal background model has not been exceeded, control returns to 601. It should be appreciated that other events may trigger the creation of a new universal background template. For example, a detection of a context or activity change may result in the creation of a new universal background template.

At 604, control determines that a new universal background model is to be generated. The present universal background model is stored in a trusted execution environment.

FIGS. 3-6 are flow charts illustrating methods according to exemplary embodiments of the present disclosure. Some of the techniques illustrated in these figures may be performed sequentially, in parallel or in an order other than that which is described. It should be appreciated that not all of the techniques described are required to be performed, that additional techniques may be added, and that some of the illustrated techniques may be substituted with other techniques.

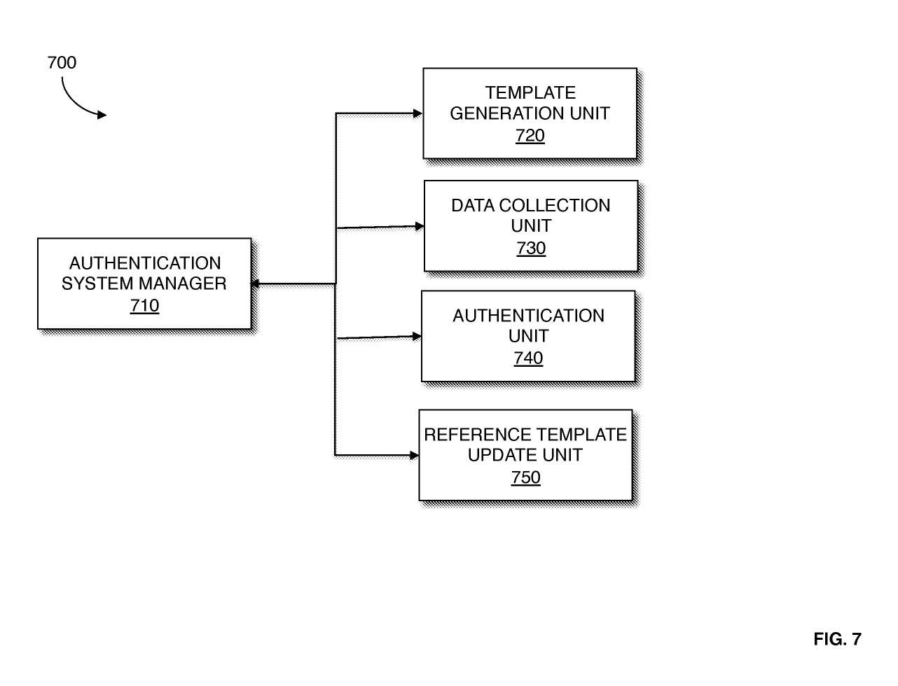

FIG. 7 is a block diagram of an authentication system 700 according to an exemplary embodiment of the present disclosure. FIG. 7 illustrates modules implementing an embodiment of the authentication system 700. According to one embodiment, the modules represent software modules and authentication of an individual may be performed by a computing device such as the one illustrated in FIG. 1 executing sequences of instructions represented by the modules shown in FIG. 7. Execution of the sequences of instructions causes the computing device to support user authentication and reference template management. In alternate embodiments, hard-wire circuitry may be used in place of or in combination with software instructions to implement embodiments of present disclosure. Thus, embodiments of present disclosure are not limited to any specific combination of hardware circuitry and software. The authentication system 700 includes an authentication system manager 710. The authentication system manager 710 is connected to and transmits data between the other components of the authentication system 700.

The authentication system 700 includes a template generation unit 720. According to an embodiment of the present disclosure, the template generation unit 720 generates a reference template that include data that corresponds to a user that characterizes the user's behavior pattern. The data may include behaviometric data sampled from sensors during an initial training period. The template generation unit 720 may perform the procedures described with reference to FIG. 4 to generate the reference template.

The authentication system 700 includes a data collection unit 730. According to an embodiment of the present disclosure, the data collection unit 730 interfaces with a plurality of sensors that generate data that corresponds to an individual that may or may not be the user.

The authentication system 700 includes an authentication unit 740. According to an embodiment of the present disclosure, the authentication unit tests the authenticity of an individual by comparing current data associated with the individual with data in the reference template. The individual is determined to be authentic if the current data associated with the individual exceeds a threshold amount of matching with the reference template. The authentication unit 740 may utilize various techniques may be implemented to perform the comparison and matching including False Accept Rate (FAR) and False Reject Rate (FRR) comparisons. According to an embodiment of the present disclosure, the determination on whether to test the authenticity of the individual may be based on an initiation of a transaction, a request to utilize functions on the computing device, an attempt to access data, an expiration of a predetermined period of time, and/or other triggering event. In an alternate embodiment, the authenticity of the individual is continuously tested without requiring the triggering event.

The authentication system 700 includes a reference template update unit 750. According to an embodiment of the present disclosure, a universal background model is generated that includes additional data that corresponds to the user that further characterizes the user's behavior pattern. The data may include additional behaviometric data sampled from sensors after the initial training period. The universal background model may be generated by the template generation unit 720 which may perform the procedures described with reference to FIG. 5. The reference template update unit 750 may update the reference template by utilizing data from the universal background model. According to an embodiment of the present disclosure, a learning anomaly detection technique such as a Bayesian inference algorithm is applied to the universal background model and the reference template. Hamming distance between minutia points in the reference template and background model are computed. The minutia points in the reference template are adjusted by summing the natural log of the Hamming distances computed.

It should be appreciated that the reference template update unit 750 may update the reference template by utilizing data from the universal background in a different manner. For instance, if a determination is made that the universal background model captured new behavior of the user not reflected in the reference template, the data from the universal background model may be added to the reference template.

The authentication system manager 710 may generate test results that indicate whether the individual has been authenticated and is the user. The test result may be output on the computing device and/or transmitted outside the computing device.

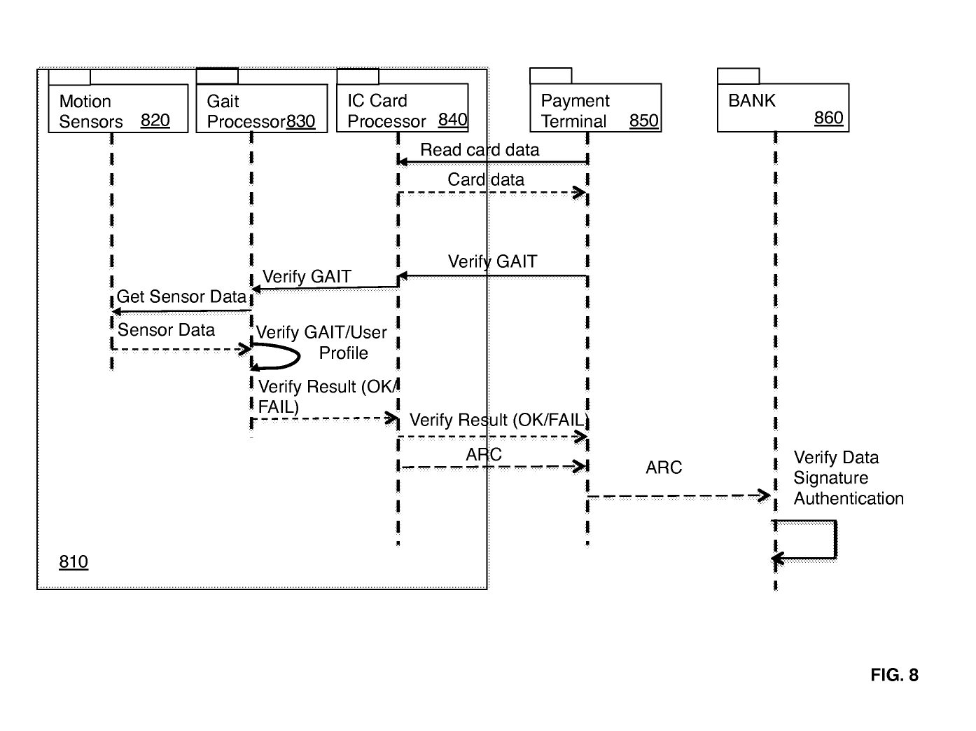

FIG. 8 is a diagram illustrating an example of a commerce transaction utilizing an authentication procedure according to an exemplary embodiment of the present disclosure. In this example, a computing device 810 includes motion sensors 820, a gait processor 830, and an integrated circuit (IC) card processor 840. The motion sensors 820 may be implemented with the sensors described with reference to FIG. 1. The gait processor 830 may be implemented with the authentication system described with reference to FIGS. 1 and 7. The IC card processor 840 may be a mechanism that supports secure payment transactions and may include a near field communication circuitry to communicate with a payment terminal. The computing device 810 may communicate with a payment terminal 850 residing outside the computing device.

According to an embodiment of the present disclosure, the payment terminal 850 may attempt to initiate a secure payment transaction with the IC card processor 840. The IC card processor 840 attempts to verify with the gait processor 830 that the individual currently in possession of the computing device 800 is indeed the owner/user of the computing device 800. As described with reference to FIGS. 1-7, the gait processor 830 may authenticate an individual by comparing current data collected from motion sensors 820 with a reference template to determine whether the current data collected exceeds a threshold amount of matching to data in the reference template. The gait processor 830 transmits an indication to the IC card processor 840 as to whether the individual has been authenticated as the owner/user of the computing device 800.

The IC card processor 840 may subsequently transmit the indication to the payment terminal 850 along with an authorization request cryptogram (ARC). The authorization request cryptogram may include a signature of a trusted execution environment which the computing device 800 utilizes to perform its authentication. The authorization request cryptogram may also include the transaction data which may be the current data sampled from the motion sensors 830. The payment terminal 850 may transmit the authorization request cryptogram to a bank 860 or other entity to verify that trusted execution environment is trustworthy and that the individual in possession of the computing device 800 is trustworthy.

Embodiments of the present disclosure may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing or encoding a sequence of instructions for execution by the machine and that cause the machine to perform any one of the methods described herein. Furthermore, it is common in the art to speak of software, in one form or another (e.g., code, program, procedure, process, application, module, unit, logic, block, and so on) as taking an action or causing a result. Such expressions are merely a shorthand way of stating that the execution of the software by a processing system causes the processor to perform an action to produce a result.

The following examples pertain to further embodiments. In one embodiment, a method for managing a reference template for authentication includes generating the reference template using gait data collected during a training period. A user is authenticated utilizing the reference template. A universal background model (UBM) is generated using gait data collected after the training period. The reference template is updated using the UBM.

In a further embodiment, generating the reference template includes collecting the gait data from a sensor, filtering noise from the gait data, and identifying characteristics unique to the user from the gait data.

In a further embodiment, an indication is transmitted that the user is authentic in response to determining that current gait data collected exceeds a threshold amount of matching to the gait data in the reference template.

In a further embodiment, generating the UBM includes authenticating the user, collecting new gait data from a sensor, filtering noise from the new gait data, and identifying characteristics unique to the user from the new gait data.

In a further embodiment, updating the reference template using the UBM includes computing Hamming distances between minutia points in the reference template and the UBM, and summing a natural log of the Hamming distances on the reference template.

In a further embodiment, updating the reference template using the UBM is achieved by including gait data from the UBM in the reference template.

In a further embodiment, the generating, authenticating, and updating is performed continuously without interrupting the user.

In a further embodiment, the generating, authenticating, and updating is performed within a trusted execution environment (TEE) within a personal computing device.

In a further embodiment, the TEE is an isolated region in memory where code and data is encrypted.

In a further embodiment, transmitting the indication that the user is authentic includes transmitting an authorization request cryptogram to a payment terminal.

In a further embodiment, the authorization request cryptogram includes a signature of a trusted execution environment within a personal computing device.

In a further embodiment, the authorization request cryptogram includes the gait data.

In a further embodiment, the sensor resides in a personal computing device.

In a further embodiment, the sensor is an accelerometer.

In a further embodiment, a non-transitory computer-readable medium having sequences of instructions, the sequences of instructions including instructions which, when executed, causes a processor to perform the method of any of the above disclosed embodiments.

In a further embodiment, a non-transitory computer-readable medium having sequences of instructions, the sequences of instructions including instructions which, when executed, cause a processor to perform a method that generating a reference template using gait data collected during a training period. A user is authenticated utilizing the reference template. A universal background model (UBM) is generated using gait data collected after the training period. The reference template is updated using the UBM.

In a further embodiment, the above referenced non-transitory computer-readable medium further includes transmitting an indication that the user is authentic in response to determining that current gait data collected exceeds a threshold amount of matching to the gait data in the reference template.

In a further embodiment, updating the reference template using the UBM includes including gait data from the UBM in the reference template.

In a further embodiment, an authentication system includes a template generation unit that generates a reference template using gait data collected during a training period. The authentication system also includes an authentication unit that authenticates a user utilizing the reference template. The authentication system also includes a reference template update unit that updates the reference template with a universal background model (UBM) that includes gait data collected after the training period.

In a further embodiment, the authentication system further includes an authentication system manager that generates a test result that indicates whether the user has been authenticated and transmits that test result outside the computing device.

In a further embodiment, the authentication unit determines whether current gait data collected exceeds a threshold amount of matching to the gait data in the reference template.

In a further embodiment, an apparatus for performing authentication includes means for generating a reference template using gait data collected during a training period. The apparatus includes means for authenticating a user utilizing the reference template. The apparatus includes means for updating the reference template with a universal background model (UBM) that includes gait data collected after the training period.

In a further embodiment, the above referenced apparatus for performing authentication further includes means for generating a test result that indicates whether the user has been authenticated and transmits that test result outside the computing device.

In a further embodiment, the means for authentication determines whether current gait data collected exceeds a threshold amount of matching to the gait data in the reference template.

In the foregoing specification embodiments of the disclosure have been described with reference to specific exemplary embodiments thereof. It will, however, be evident that various modifications and changes may be made thereto without departing from the embodiments of the disclosure. Furthermore, it should be appreciated that specifics in the examples presented may be used anywhere in one or more of the disclosed embodiments.

In the claims what is claimed is:

1. A non-transitory computer-readable medium having sequences of instructions, the sequences of instructions including instructions which, when executed, cause a processor to perform a method for managing a reference template for authentication, comprising:
generating the reference template using gait data collected during a training period;
authenticating a user utilizing the reference template;
generating a universal background model (UBM) using gait data collected after the training period; and
updating the reference template using the UBM.

2. The non-transitory computer-readable medium of claim 1, wherein generating the reference template comprises:
collecting the gait data from a sensor;
filtering noise from the gait data; and
identifying characteristics unique to the user from the gait data.

3. The non-transitory computer-readable medium of claim 1, wherein the method further comprises transmitting an indication that the user is authentic in response to determining that current gait data collected exceeds a threshold amount of matching to the gait data in the reference template.

4. The non-transitory computer-readable medium of claim 1, wherein generating the UBM comprises:
authenticating the user;
collecting new gait data from a sensor;
filtering noise from the new gait data; and
identifying characteristics unique to the user from the new gait data.

5. The non-transitory computer-readable medium of claim 1, wherein updating the reference template using the UBM comprises:
computing Hamming distances between minutia points in the reference template and the UBM; and
summing a natural log of the Hamming distances on the reference template.

6. The non-transitory computer-readable medium of claim 1, wherein updating the reference template using the UBM comprises including gait data from the UBM in the reference template.

7. The non-transitory computer-readable medium of claim 1, wherein the generating, authenticating, and updating is performed continuously without interrupting the user.

8. The non-transitory computer-readable medium of claim 1, wherein the generating, authenticating, and updating is performed within a trusted execution environment (TEE) within a personal computing device.

9. The non-transitory computer-readable medium of claim 8, wherein the TEE is an isolated region in memory where code and data is encrypted.

10. The non-transitory computer-readable medium of claim 3, wherein transmitting the indication that the user is authentic comprises transmitting an authorization request cryptogram to a payment terminal.

11. The non-transitory computer-readable medium of claim 10, wherein the authorization request cryptogram comprises a signature of a trusted execution environment within a personal computing device.

12. The non-transitory computer-readable medium of claim 10, wherein the authorization request cryptogram comprises the gait data.

13. The non-transitory computer-readable medium of claim 2, wherein the sensor resides in a personal computing device.

14. The non-transitory computer-readable medium of claim 2, wherein the sensor is an accelerometer.

15. A method for managing a reference template for authentication comprising:
generating the reference template using gait data collected during a training period;
authenticating a user utilizing the reference template;
generating a universal background model (UBM) using gait data collected after the training period; and
updating the reference template using the UBM.

16. The method of claim 15, wherein the method further comprises transmitting an indication that the user is authentic in response to determining that current gait data collected exceeds a threshold amount of matching to the gait data in the reference template.

17. The method of claim 15, wherein updating the reference template using the UBM comprises including gait data from the UBM in the reference template.

18. An authentication system, comprising:
a template generation unit that generates a reference template using gait data collected during a training period;
an authentication unit that authenticates a user utilizing the reference template; and
a reference template update unit that updates the reference template with a universal background model (UBM) that includes gait data collected after the training period.

19. The authentication system of claim 18 further comprising an authentication system manager that generates a test result that indicates whether the user has been authenticated and transmits that test result outside the computing device.

20. The authentication system of claim 18, wherein the authentication unit determines whether current gait data collected exceeds a threshold amount of matching to the gait data in the reference template.
